(19) United States
(12) Patent Application Publication
(10) Pub. No.: US 2010/0187280 A1
(43) Pub. Date: Jul. 29, 2010

(54) COMBUSTION-TYPE POWER TOOL

(76) Inventors: Yoshitaka Akiba, Ibarki-ken (JP); Yukiyoshi Maehara, Ibaraki-ken (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/440,065

(22) PCT Filed: Aug. 31, 2007
(86) PCT No.: PCT/JP2007/067461

§ 371 Date: Mar. 5, 2009

(30) Foreign Application Priority Data
Sep. 5, 2006 (JP) 2006-239751

(51) Int. Cl. B25C 1/08

(52) U.S. Cl. 227/10

(57) ABSTRACT

A combustion-type power tool includes a housing, a cylinder head, a cylinder, a push lever, a piston, a combustion-chamber frame, and an urging member. The cylinder head is disposed at a first end of the housing. The cylinder is disposed in and fixed to the housing. The cylinder has an inner space. The push lever is disposed at a second end of the housing. The piston is slidably disposed in the cylinder and is reciprocally movable in an axial direction. The combustion-chamber frame is disposed in the housing and provides a combustion chamber in cooperation with the cylinder head and the piston. The urging member has one end attached to the piston and another end attached to an axial end of the cylinder, thereby urging the piston in a direction from the second end toward the first end.

### TECHNICAL FIELD

The present invention relates to a combustion-type power tool.

### BACKGROUND ART

Combustion-type power tools such as a nail gun is well known in the art. The power tool ignites a gas mixture containing fuel that is injected into a combustion chamber and translates the volumetric expansion of the gas into power. A combustion-type power tool having this structure includes a housing, a cylinder, and a piston. The housing has first and second ends. The cylinder is fixed in the housing with its axial direction oriented in a direction from the first end to the second end of the housing.

The piston is provided in the cylinder and is capable of slidingly reciprocating relative to the cylinder in the axial direction thereof. The piston divides an inner space of the cylinder into an upper space above the piston and near the first end, and a lower space below the piston and near the second end. A driver blade extends from the piston toward the second end. The driver blade and piston are configured to slide together. An exhaust hole in communication with an atmosphere is formed in the cylinder, and a check valve is disposed in the exhaust hole. A combustion chamber is defined by the piston, cylinder, and the like.

When driving a nail with the power tool, liquefied gas is injected into the combustion chamber, mixing with air to form an air-fuel mixture that is explosively combusted. This combustion causes the piston to slide together with the driver blade from the first end to the second end of the housing, at which time the driver blade drives the nail into the wood or other workpiece. During this operation, the check valve is open, allowing exhaust gas produced by the combustion to be exhausted from the combustion-type power tool through the exhaust hole. After the liquefied gas is combusted in the upper space, the check valve is closed to hermetically seal the combustion chamber. Consequently, the pressure in the combustion chamber drops due to a drop in temperature in the upper space, creating a thermal vacuum in the upper space. As a result, the pressure in the lower space becomes high relative to the pressure in the upper space so that the piston is returned to the initial top dead center. One example of the combustion-type power tool is described in Japanese Patent Application Publication No. HEI-1-34753.

### DISCLOSURE OF THE INVENTION

However, in the above-described conventional combustion-type power tool, the piston may not completely return to the initial top dead center when the seal of the check valve degrades or cooling in the upper space is insufficient, making the combustion chamber too large for the next nail driving operation. When the combustion chamber is too large, the air-fuel mixture produced in the chamber has a low concentration of combustible gas and may not combust, resulting in a failed nail driving operation.

In view of the foregoing, it is an object of the present invention to provide a combustion-type power tool capable of reliably returning the piston to the initial top dead center.

In order to attain the above and other objects, the present invention provides a combustion-type power tool. The combustion-type power tool includes a housing, a cylinder head, a cylinder, a push lever, a piston, a combustion-chamber frame, and an urging member. The cylinder head is disposed at a first end of the housing. The cylinder is disposed in and fixed to the housing. The cylinder has an inner space. The push lever is disposed at a second end of the housing. The piston is slidably disposed in the cylinder and is reciprocally movable in an axial direction. The combustion-chamber frame is disposed in the housing and provides a combustion chamber in cooperation with the cylinder head and the piston. The urging member has one end attached to the piston and another end attached to an axial end of the cylinder, thereby urging the piston in a direction from the second end toward the first end.

It is preferable that the combustion-type power tool further include an exhaust hole and a check valve. The exhaust hole is formed at the cylinder and allows the inner space in communication with an atmosphere. The check valve is disposed in the exhaust port. The check valve is configured to allow air in the inner space to be discharged to outside the cylinder and to prevent air outside the cylinder from flowing into the inner space.

It is also preferable that the combustion-type power tool further include a bumper disposed in the inner space and at the axial end of the cylinder, and a driver blade extending from the piston toward the second end. The bumper is formed with a through-hole for allowing penetration of the driver blade and for accommodating the urging member.

It is also preferable that the urging member include a coil spring, and that the coil spring be disposed in the inner space below the piston and around the driver blade and coaxially positioned with respect to the driver blade.

It is also preferable that the piston be movable between a top dead center at the first end side and a bottom dead center at the second end side, and that the coil spring be accommodated in the through-hole in a contracted state when the piston is positioned at the bottom dead center, and the coil spring extend between the piston and the axial end of the cylinder in an expanded state when the piston is positioned at the top dead center.

### BRIEF DESCRIPTION OF THE DRAWINGS

FIG. 1 is a vertical cross-sectional view of a combustion-type power tool according to an embodiment of the present invention, in which a push lever is separated from a workpiece such that a combustion chamber is in a nonsealed state; and

FIG. 2 is a vertical cross-sectional view of the combustion-type power tool according to the embodiment, in which the push lever is pressed against the workpiece such that a sealed combustion chamber is provided.

### BRIEF DESCRIPTION OF REFERENCE NUMERALS

1: combustion-type nail gun

2: housing

3: head cover

4: handle

5: trigger switch

6: magazine

7: nose

8: arm member

9: push lever

10: combustion-chamber frame

11: cylinder head

18: motor

19: fan

20: cylinder

21: exhaust hole

22: compression coil spring

23: piston

23A: drive blade

23B: spring

24: bumper

26: combustion chamber

26a, 26b: air flow passage

28: workpiece

### BEST MODE FOR CARRYING OUT THE INVENTION

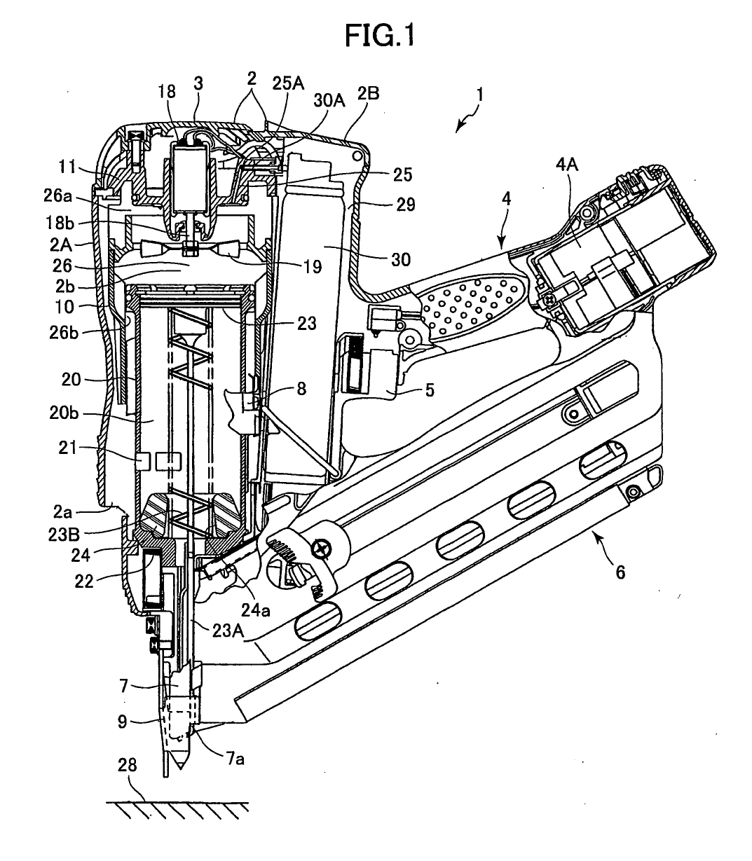

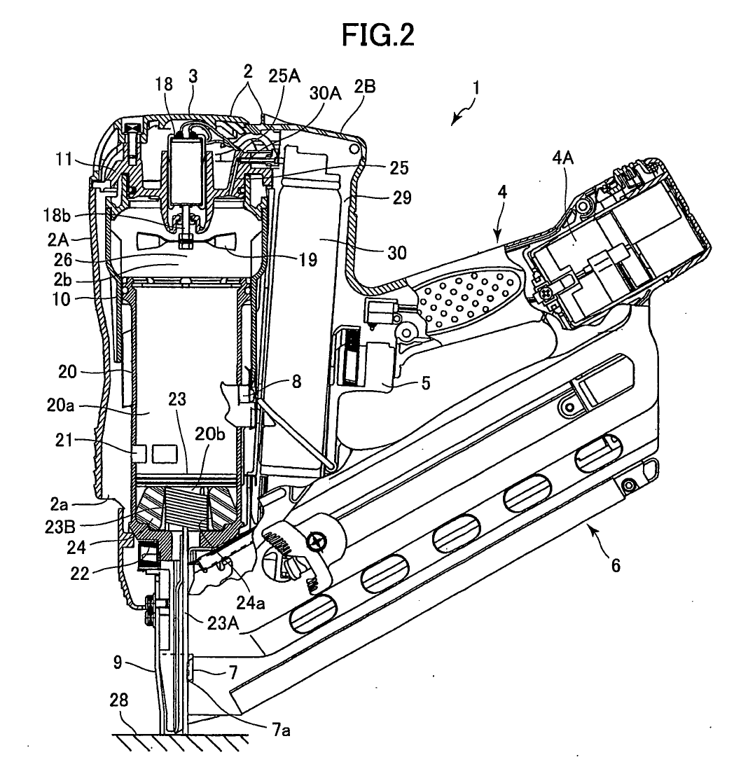

A combustion-type power tool according to an embodiment of the present invention will be described with reference to FIGS. 1 and 2. The embodiment pertains to a combustion-type nail gun. As shown in FIG. 1, a combustion-type nail gun 1 has a housing 2 constituting an outer frame and including a first housing 2A and a second housing 2B. The first housing 2A extends in a longitudinal direction (axial direction), and has a first end (an upper end in FIGS. 1 and 2) and a second end (a lower end in FIGS. 1 and 2). The first housing 2A is formed with an exhaust port 2a. The second housing 2B is mounted on a side of the first housing 2A. A part of the second housing 2B constitutes a handle 4 which is adapted to be gripped by a user. A head cover 3 having an air inlet (not shown) formed therein is mounted on top of the first housing 2A.

The handle 4 has a trigger switch 5 and accommodates therein a battery 4A. The battery 4A is detachably disposed in the handle 4. A canister housing 29 is provided in the second housing 2B at a position beside the first housing 2A. A gas canister 30 containing a combustible liquidized gas is detachably disposed in the canister housing 29. A magazine 6 for containing therein nails (not shown) is provided at a lower side of the handle 4.

A nose 7 extends from the second end of the first housing 2A, the second end being opposite to the head cover 3. The nose 7 is formed integrally with a cylinder 20 (described later) and has a tip end in confrontation with a workpiece 28. The nose 7 is adapted for guiding sliding movement of a drive blade 23A (described later) and the nail. A push lever 9 is movably provided and has a lower portion slidable with respect to a lower end portion 7a of the nose 7. The push lever 9 has a tip end adapted to be pressed against the workpiece 28, and has an upper end portion associated with an arm member 8 fixed to a combustion-chamber frame 10 which will be described later.

A compression coil spring 22 is interposed between the arm member 8 and the cylinder 20 for normally urging the push lever 9 in a protruding direction away from the head cover 3. When the housing 2 is pressed toward the workpiece 28 while the push lever 9 is in abutment with the workpiece 28 against a biasing force of the compression coil spring 22, an upper portion of the push lever 9 is retractable into the housing 2.

A cylinder head 11 is secured to the top of the first housing 2A for closing the open top end of the first housing 2A. The cylinder head 11 supports a motor 18 at a position opposite to a combustion chamber 26 described later. Further, an ignition plug (not shown) is also supported to the cylinder head 11 at a position adjacent to the motor 18. The ignition plug has an ignition spot exposed to the combustion chamber 26. The ignition plug is ignitable upon manipulation to the trigger switch 5 and upon movement of the combustion-chamber frame 10 to its predetermined position because of the pressing of the push lever 9 against the workpiece 28. The motor 18 has an output shaft 18b to which a fan 19 positioned in the combustion chamber 26 is fixed.

A head switch (not shown) is provided in the first housing 2A for detecting an uppermost stroke end position of the combustion-chamber frame 10 when the nail gun 1 is pressed against the workpiece 28. The head switch can be turned ON when the push lever 9 is elevated to a predetermined position for starting rotation of the motor 18.

A piston 23 is slidably and reciprocally provided in the cylinder 20. As shown in FIG. 2, the piston 23 divides an inner space of the cylinder 20 into an upper space 20a above the piston 23 and a lower space 20b below the piston 23. The driver blade 23A extends downwards (in a direction from the first end to the second end) from a side of the piston 23, the side being at the lower space 20b, to the nose 7. The driver blade 23A is positioned coaxially with the nail setting position in the nose 7, so that the driver blade 23A can strike against the nail during movement of the piston 23 toward its bottom dead center.

A bumper 24 is provided on the bottom of the cylinder 20. The bumper 24 is formed with a through-hole 24a for allowing penetration of the driver blade 23A and for accommodating a spring 23B (described later). The bumper 24 is made from a resilient material. When the piston 23 moves to its bottom dead center, the piston 23 abuts on the bumper 24 and stops. In this case, the bumper 24 absorbs a surplus energy of the piston 23.

A fuel injection passage 25 is formed in the cylinder head 11 on the handle 4 side thereof. One end of the fuel injection passage 25 communicates with an opening in the bottom surface of the cylinder head 11, while the other end forms a gas canister connecting portion 25A. The gas canister connecting portion 25A is connected to an injection rod 30A constituting an injection port of the gas canister 30.

The combustion-chamber frame 10 has a substantially cylindrical shape and is disposed in the first housing 2A. The combustion-chamber frame 10 is movable in the longitudinal direction (axial direction) of the first housing 2A, and the top end of the combustion-chamber frame 10 is abuttable on the bottom surface of the cylinder head 11. Since the arm member 8 is coupled to the combustion-chamber frame 10 as described above, the combustion-chamber frame 10 moves in association with movement of the push lever 9. The combustion-chamber frame 10 has an inner surface in sliding contact with the cylinder 20. Thus, the cylinder 20 guides movement of the combustion-chamber frame 10. An exhaust hole 21 in communication with an atmosphere is formed in the cylinder 20 in a region near a center part in the axial direction.

When combustible gas in the combustion chamber 26 ignites, as will be described later, the piston 23 slides in a direction from the first end to the second end. Since the exhaust hole 21 is in communication with an external space of the cylinder 20 (the external space is in communication with the atmosphere through the exhaust hole 2a), gas in the lower space 20b is discharged out of the housing 2 through the exhaust hole 21 and the exhaust hole 2a. Hence, this structure can prevent air in the lower space 20b from acting as an air damper to impede downward movement of the piston 23. Further, exhaust gas remaining after the combustible gas in the combustion chamber 26 is ignited can also be exhausted out of the housing 2 via the exhaust hole 21 and the exhaust hole 2a.

The spring 23B (a coil spring in the embodiment) is disposed in the cylinder 20 around the driver blade 23A and coaxially positioned with respect to the driver blade 23A. One end (upper end) of the spring 23B is attached to the piston 23, while the other end (lower end) is attached to an axial end of the cylinder 20 at the second end side. When the piston 23 is positioned at its bottom dead center (FIG. 2), the spring 23B is accommodated in the through-hole 24a of the bumper 24 in a contracted state. When the piston 23 is positioned at its top dead center (FIG. 1), the spring 23B extends between the piston 23 and the axial end of the cylinder 20 in an expanded state.

The spring 23B urges the piston 23 in a direction from the second end to the first end (an upward direction in FIGS. 1 and 2) with a relatively weak urging force of approximately 5 kgf (kilogram force). This force corresponds to a force of moving the piston 23 and driver blade 23A totaling about 100 grams in weight from the second end to the first end when the spring 23B is omitted and the lower space 20b has a pressure of 0.2 atm. Accordingly, the urging force of the spring 23B is very weak and will not impede the piston 23 from moving downward in FIG. 1 when combustion in the combustion chamber 26 generates a downward pressing force.

By providing the spring 23B described above, the piston 23 can be quickly returned to its top dead center by the urging force of the spring 23B, regardless of whether a sufficient thermal vacuum is produced in the upper space 20a. Therefore, nail driving operations can be performed more rapidly in succession. Further, the combustion-type nail gun 1 can be produced at a low cost, since a check valve or the like required for achieving a sufficient thermal vacuum need not be provided in the exhaust hole 21.

When the upper end of the combustion-chamber frame 10 abuts on the cylinder head 11, the cylinder head 11, the combustion-chamber frame 10, and the piston 23 define the combustion chamber 26. When the combustion-chamber frame 10 is separated from the cylinder head 11 (FIG. 1), a first flow passage 26a in communication with an atmosphere is provided between the cylinder head 11 and the upper end portion of the combustion-chamber frame 10, and a second flow passage 26b in communication with the first flow passage 26a is provided between the lower end portion of the combustion-chamber frame 10 and the upper end portion of the cylinder 20. These flow passages 26a and 26b allow a combustion gas and a fresh air to pass along the outer peripheral surface of the cylinder 20 for discharging these gas through the exhaust hole 2a of the housing 2. Further, the above-described air inlet (not shown) of the head cover 3 is formed for supplying a fresh air into the combustion chamber 26, and the exhaust hole 21 is adapted for discharging combustion gas generated in the combustion chamber 26.

The fan 19 is disposed inside the combustion chamber 26. The fan 19 is fixed to the output shaft 18b of the motor 18 and can rotate together with the output shaft 18b. Rotation of the fan 19 performs the following three functions. First, the fan 19 stirs and mixes the air with the combustible gas as long as the combustion-chamber frame 10 remains in abutment with the cylinder head 11. Second, after the mixed gas has been ignited, the fan 19 causes turbulent combustion of the air-fuel mixture, thus promoting the combustion of the air-fuel mixture in the combustion chamber 26. Third, the fan 19 performs scavenging such that the exhaust gas in the combustion chamber 26 can be scavenged therefrom and also performs cooling to the combustion-chamber frame 10 and the cylinder 20 when the combustion-chamber frame 10 moves away from the cylinder head 11 and when the first and second flow passages 26a and 26b are provided.

Next, operation of the combustion-type nail gun 1 will be described. In the non-operational state of the combustion-type nail gun 1, the push lever 9 is biased away from the cylinder head 11 as shown in FIG. 1 by the biasing force of the compression coil spring 22, so that the push lever 9 protrudes from the lower end of the nose 7. Thus, the combustion-chamber frame 10 is spaced away from the cylinder head 11 because the arm member 8 connects the combustion-chamber frame 10 to the push lever 9. Further, a part of the combustion-chamber frame 10 which part defines the combustion chamber 26 is also spaced away from the top portion of the cylinder 20. Hence, the first and second flow passages 26a and 26b are provided. In this state, the piston 23 stays at its top dead center in the cylinder 20.

With this state, if the push lever 9 is pushed onto the workpiece 28 while the handle 4 is held by the user, the push lever 9 is moved toward the cylinder head 11 against the biasing force of the compression coil spring 22. At the same time, the combustion-chamber frame 10 which is associated with the push lever 9 through the arm member 8 is also moved toward the cylinder head 11, closing the above-described flow passages 26a and 26b. Thus, the sealed combustion chamber 26 is provided.

When the push lever 9 is moved toward the cylinder head 11, the gas canister 30 inclines toward the cylinder head 11 so that the injection rod 30A of the gas canister 30 presses against the gas canister connecting portion 25A of the cylinder head 11. At this time, liquidized gas in the gas canister 30 is injected once into the combustion chamber 26 through the injection port of the fuel injection passage 25.

Further, in accordance with the movement of the push lever 9, the combustion-chamber frame 10 reaches its uppermost stroke end whereupon the head switch is turned ON to energize the motor 18 for starting rotation of the fan 19. Rotation of the fan 19 stirs and mixes the combustible gas with air in the combustion chamber 26.

In this state, when the trigger switch 5 provided at the handle 4 is turned ON, spark is generated at the ignition plug to ignite the combustible gas. The combusted and expanded gas pushes the piston 23 to its bottom dead center. Therefore, a nail in the nose 7 is driven into the workpiece 28 by the driver blade 23A until the piston 23 abuts on the bumper 24.

After the nail driving, the piston 23 strikes against the bumper 24, the upper space 20a (FIG. 2) in the cylinder 20 becomes communicated with the exhaust hole 21. Thus, the high pressure and high temperature combustion gas is discharged out of the cylinder 20 through the exhaust hole 21 to the atmosphere to lower the pressure in the combustion chamber 26. At this time, an urging force of the spring 23B provided on the piston 23 forces the piston 23 to slide in the cylinder 20 in a direction from the second end to the first end, quickly returning the piston 23 to its top dead center.

Then, the trigger switch 5 is turned OFF, and the user lifts the combustion-type nail gun 1 from the workpiece 28 for separating the push lever 9 from the workpiece 28. As a result, the push lever 9 and the combustion-chamber frame 10 move away from the cylinder head 11 because of the biasing force of the compression coil spring 22 to restore a state shown in FIG. 1. Thus, the first and second flow passages 26a and 26b are provided. In this case, the fan 19 is configured to keep rotating for a predetermined period of time in spite of OFF state of the trigger switch 5.

In the state shown in FIG. 1, the first and second flow passages 26a and 26b are provided as described above. The fan 19 generates an airflow to draw in fresh air through the air inlet (not shown) provided in the head cover 3 and to exhaust combusted air through the exhaust hole 2a, facilitating scavenging of air in the combustion chamber 26. Then, rotation of the fan 19 is stopped to restore an initial stationary state. Thereafter, subsequent nail driving operations can be performed by repeating the above-described operation process.

While the invention has been described in detail and with reference to specific embodiments thereof, it would be apparent to those skilled in the art that various changes and modification may be made therein without departing from the scope of the claims.

For example, a check valve may be provided in the exhaust hole of the cylinder to allow the discharge of gas from the cylinder while preventing air from flowing into the cylinder. When operating a combustion-type power tool according to this modification, the piston impacts the bumper and combusted gas is discharged from the cylinder through the exhaust hole immediately after driving a nail. Since the combusted gas remaining in the cylinder and the combustion chamber is hot immediately after combustion, the inner walls of the cylinder and the combustion-chamber frame absorb the combustion heat and, consequently, rise in temperature. This absorbed heat is dissipated in air flowing over the outer wall surfaces of the cylinder and the combustion-chamber frame.

Since the cylinder and the like absorb the combustion heat from the combusted gas in this way, the combusted gas is cooled rapidly and decreases in volume, producing a thermal vacuum in which the pressure in the upper space drops below atmospheric pressure. In addition, the urging force of the spring provided on the piston urges the piston to slide in the cylinder in a direction from the second end to the first end, thereby quickly drawing the piston back to its top dead center.

Further, since the check valve of this modification can prevent air from flowing into the upper space, a sufficient thermal vacuum can be obtained in this space. In this way, the piston can be returned even more quickly to its initial top dead center when the check valve is provided in combination with the spring.

Further, since the thermal vacuum produced in the upper space generates a force for sliding the piston in a direction from the second end to the first end, a spring with a very low urging force can be used. In this way, it is possible to prevent the urging force of the spring from hindering the piston in moving in a direction from the first end to the second end (downward movement during combustion).

In the above-described embodiment, the nail gun is described as an example of the combustion-type power tool. However, the present invention is not limited to the nail gun but is available for any kind of power tools in which a combustion chamber and a piston are provided, and as long as expansion of gas as a result of combustion of air-fuel mixture in the combustion chamber causes reciprocal motion of the piston.

### INDUSTRIAL APPLICABILITY

A combustion-type power tool according to the present invention can be applied to power tools such as a nail gun for driving a nail into a workpiece.

1. A combustion-type power tool comprising:
a housing;
a cylinder head disposed at a first end of the housing;
a cylinder disposed in and fixed to the housing, the cylinder having an inner space and formed with an exhaust hole that allows the inner space in communication with an atmosphere;
a push lever disposed at a second end of the housing;
a piston slidably disposed in the cylinder and reciprocally movable in an axial direction;
a combustion-chamber frame disposed in the housing and providing a combustion chamber in cooperation with the cylinder head and the piston;
a check valve that is disposed in the exhaust hole, the check valve being configured to allow air in the inner space to be discharged to outside the cylinder and to prevent air outside the cylinder from flowing into the inner space, thereby obtaining a thermal vacuum in the inner space; and
an urging member having one end attached to the piston and another end attached to an axial end of the cylinder, thereby urging the piston in a direction from the second end toward the first end in combination with the thermal vacuum.

2. (canceled)

3. The combustion-type power tool as claimed in claim 1, further comprising:
a bumper disposed in the inner space and at the axial end of the cylinder; and
a driver blade extending from the piston toward the second end,
wherein the bumper is formed with a through-hole for allowing penetration of the driver blade and for accommodating the urging member.

4. The combustion-type power tool as claimed in claim 3, wherein the urging member comprises a coil spring; and
wherein the coil spring is disposed in the inner space below the piston and around the driver blade and coaxially positioned with respect to the driver blade.

5. The combustion-type power tool as claimed in claim 4, wherein the piston is movable between a top dead center at the first end side and a bottom dead center at the second end side; and
wherein the coil spring is accommodated in the through-hole in a contracted state when the piston is positioned at the bottom dead center, and the coil spring extends between the piston and the axial end of the cylinder in an expanded state when the piston is positioned at the top dead center.
